(19) United States
(12) Patent Application Publication
(10) Pub. No.: US 2008/0230364 A1
(43) Pub. Date: Sep. 25, 2008

(54) Joystick control device

(76) Inventor: Paul Treuthardt, Monroe, WI (US)

Correspondence Address: DAVID J. ARCHER, 7037 POMERY ROAD, ROCKTON, IL, 61072, US

(21) Appl. No.: 11/803,700

(22) Filed: May 15, 2007

Related U.S. Application Data
(60) Provisional application No. 60/800,692, filed on May 15, 2006.

(51) Int. Cl. H01H 21/00; H01H 19/00

(52) U.S. Cl. 200/6 A

(57) ABSTRACT

A joystick control device is disclosed for use in a cab of a spreader for the snow and ice control industry. The control device includes a multi-axis joystick which disposed within the cab. The joystick has a proximal and a distal end, the proximal end of the joystick being secured to the cab. A plurality of clusters of switches are mounted on the distal end of the joystick such that in operation of the control device, an operator within the cab operates the switches for controlling the snow and ice control functions of the spreader.

### CROSS REFERENCE TO RELATED APPLICATION

The present application is a Complete application pursuant to Provisional application U.S. Ser. No. 60/800,692 filed May 15, 2006. All of the disclosure of U.S. Ser. No. 60/800,692 is incorporated herein by reference.

### BACKGROUND OF THE INVENTION

1. Field of the Invention

The present invention relates to a joystick control device. More specifically, the present invention relates to a joystick control device for use in a cab of a spreader for the snow and ice control industry.

2. Background Information

Spreaders are used for removing snow and ice from roadways and to apply sand and ice melting materials to the road surface. During the aforementioned procedures, several selective and variable functions must be carried out depending on the road conditions. Such functions include spreading materials by means of rotating spinners. Whether such material is applied and the rotational speed of the spinner will depend on the actual requirements of that particular portion of the highway.

The present invention relates to a unique arrangement for centrally locating the control of such functions in a single joystick control. According to the present invention, the operation of the joystick or the functionality of the IGRIP controller is described herein. The term “IGRIP”, relates to a commercially available CAD program sold by Dassault-Systemes, of Suresnes, France.

The IGRIP Controller is a multi-function single joystick controller designed for the Snow and Ice control market. The controller contains all of the necessary functions for a typical snow plow truck in one multi-axis, multi-function joystick controller and is used in Controller area networks (CAN). As far as applicant is aware, a joystick controller has not encompassed all of the necessary hydraulic, as well as spreader functions, into a single joystick controller.

One of the attributes of the joystick device according to the present invention is the use of contact-less capacitance operator mode selection switches. These contact-less mode selection switches are “tactile” in nature, which means they are found by the operator without the need of looking. The joystick device possesses three “tactile” mode selection switches that are individually programmable by the operator. Each switch is contact-less, which means they do not have any moving mechanical parts that need to be actuated. Rather, the “tactile” switch zones only require the capacitance of the operators hand or finger to trigger the switch. These three “tactile” zones are individually programmable and control the joystick's X, Y and Z proportional Hall Effect outputs.

On the left side of the IGRIP Controller is the left switch cluster (LSC). Three function switches are included in the LSC. The LSC Switch Cluster actuates the material spreader rate increase, decrease and on/off functions.

On the right side of the IGRIP Controller is the right switch cluster (RSC) with three function switches The RSC switch cluster actuates the spinner increase and decrease, and the spreader material blast.

On the face of the IGRIP Controller is the front switch cluster (FSC) which includes five function switches. The FSC switch cluster with the five operator programmable switches are back lit switches. These switches can be programmed in the CAN network so that the operator can choose any function for a particular switch. These switches can be programmed as momentary switches or maintained switches.

Therefore, it is a primary feature of the present invention to provide a joystick control device for use in a cab of a spreader for the snow and ice control industry that overcomes the problems associated with prior art control arrangements.

Another feature of the present invention is to provide a joystick control device for use in a cab of a spreader for the snow and ice control industry that increases the controllability of the spreader and its various functions.

A further feature of the present invention is directed to a joystick control device for use in a cab of a spreader for the snow and ice control industry that make the device simple to operate and user friendly.

Other features and advantages of the present invention will be readily apparent to those skilled in the art by a consideration of the detailed description of a preferred embodiment of the present invention contained herein.

### SUMMARY OF THE INVENTION

The present invention relates to a joystick control device for use in a cab of a spreader for the snow and ice control industry. The control device includes a multi-axis joystick which is disposed within the cab. The joystick has a proximal and a distal end, the proximal end of the joystick being secured to the cab. A plurality of clusters of switches are mounted on the distal end of the joystick such that in operation of the control device, an operator within the cab operates the switches for controlling the snow and ice control functions of the spreader.

In a more specific embodiment of the present invention, the joystick has x and y axes.

Also, the x axis includes movement of the distal end of the joystick between a left and a right disposition thereof. Additionally, the y axis includes movement of the distal end of the joystick between a forward and a reverse disposition.

Moreover, the joystick has a z axis, the z axis including a rotational movement of the distal end of the joystick. The x, y and z axes are operator programmable.

Furthermore, the a plurality of clusters of switches includes a face switch cluster which is disposed on the distal end of the joystick facing the operator when operating the control device.

The face switch cluster includes a first, second, third, fourth and fifth switch. The first switch is disposed adjacent to the bottom left of the face switch cluster and the second switch is disposed adjacent to the top left of the face switch cluster. The third switch is disposed adjacent to the top center of the face switch cluster while the fourth switch is disposed adjacent to the top right of the face switch cluster. Also, the fifth switch is disposed adjacent to the bottom right of the face switch cluster. Additionally, the first, second, third, fourth and fifth switch are each operator programmable.

The a plurality of clusters of switches also includes a left switch cluster which is disposed on the distal end of the joystick on the left side thereof relative to the operator when operating the control device.

Furthermore, the left switch cluster includes a first, second and third switching device. The first switching device is disposed adjacent to the top of the left switch cluster and the second switching device is disposed adjacent to the middle of the left switch cluster. Also, the third switching device is disposed adjacent to the bottom of the left switch cluster.

Moreover, the first switching device functions to increase the spreader rate and the second switching device functions to turn the spreader on and off. Also, the third switching device functions to decrease the spreader rate.

Additionally, the a plurality of clusters of switches includes a right switch cluster which is disposed on the distal end of the joystick on the right side thereof relative to the operator when operating the control device.

The right switch cluster includes a first, second and third switch mechanism. The first switch mechanism is disposed adjacent to the top of the right switch cluster while the second switch mechanism is disposed adjacent to the middle of the right switch cluster. Also, the third switch mechanism is disposed adjacent to the bottom of the right switch cluster;

Furthermore, the first switch mechanism functions to increase a spinner rotation rate and the second switch mechanism functions to provide a spreader blast. The third switch mechanism functions to decrease a spinner rotation rate.

The switches are contact less capacitance operator mode selection switches. Also, the switches are backlit switches.

Many modifications and variation in the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view, partially in section, of a joystick control device according to the present invention disposed within a cab of a spreader for the snow and ice control industry;

FIG. 2 is an enlarged front elevational view of the joystick control device shown in FIG. 1;

FIG. 3 is a view taken on the line 3-3 of FIG. 2;

FIG. 4 is a sectional view taken on the line 4-4 of FIG. 2;

FIG. 5 is a view taken on the line 5-5 of FIG. 2; and

FIG. 6 is a view taken on the line 6-6 of FIG. 2.

Similar reference characters refer to the same parts throughout the Figures of the drawings.

### DETAILED DESCRIPTION OF THE DRAWINGS

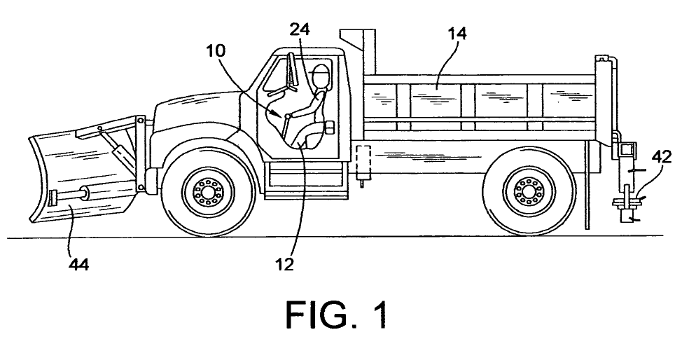

FIG. 1 is a side elevational view, partially in section, of a joystick control device generally designated 10 according to the present invention disposed within a cab 12 of a spreader 14 for the snow and ice control industry.

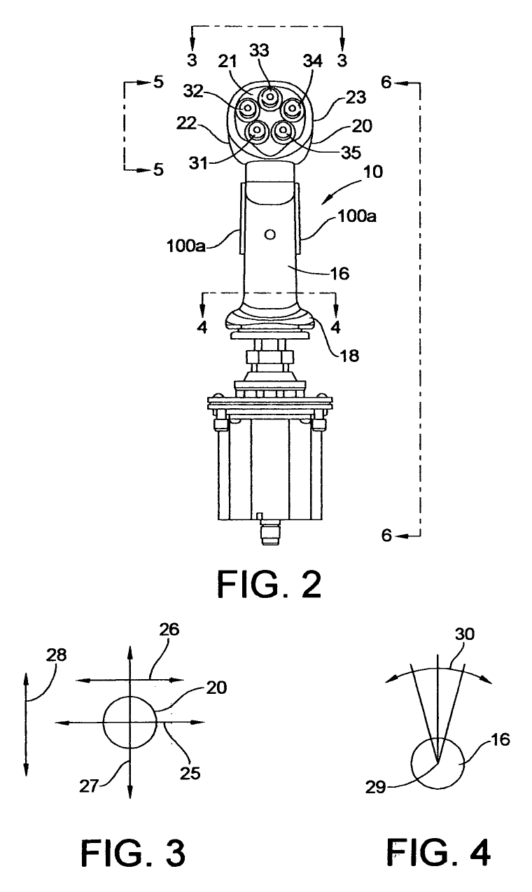

FIG. 2 is an enlarged front elevational view of the joystick control device 10 shown in FIG. 1. As shown in FIG. 2, the joystick control device 10 includes a multi-axis joystick 16 which disposed within the cab 12 as shown in FIG. 1. As shown in FIG. 2, the joystick 16 has a proximal and a distal end 18 and 20 respectively. The proximal end 18 of the joystick 16 is secured to the cab 12. A plurality of clusters of switches 21, 22 and 23 are mounted on the distal end 20 of the joystick 16 such that in operation of the control device 10, an operator 24 within the cab 12 as shown in FIG. 1, operates various switches on the clusters of switches 21-23 for controlling the snow and ice control functions of the spreader 14.

In a more specific embodiment of the present invention, the joystick 16 has x and y axes.

FIG. 3 is a view taken on the line 3-3 of FIG. 2. As shown in FIG. 3, the x axis 25 includes movement of the distal end 20 of the joystick 16 between the left and the right dispositions thereof as indicated by the arrow 26. Additionally, the y axis 27 includes movement of the distal end 20 of the joystick 16 between a forward and a reverse disposition as indicated by the arrow 28.

FIG. 4 is a sectional view taken on the line 4-4 of FIG. 2. As shown in FIG. 4, the joystick 16 has a z axis 29, the z axis 29 including a rotational movement of the distal end 20 of the joystick 16 as indicated by the arrow 30. Such rotation 30 of the distal end 20 of the joystick 16 is preferably within a range 1-15 degrees in either direction from a neutral disposition. The x, y and z axes 25, 27 and 29 respectively are programmable by the operator 24.

As shown in FIG. 2, the a plurality of clusters of switches 21-23 includes a face switch cluster 21 which is disposed on the distal end 20 of the joystick 16 facing the operator 24 when operating the control device 10.

The face switch cluster 21 includes a first, second, third, fourth and fifth switch 31, 32, 33, 34 and 35. The first switch 31 is disposed adjacent to the bottom left of the face switch cluster 21 and the second switch 32 is disposed adjacent to the top left of the face switch cluster 21. The third switch 33 is disposed adjacent to the top center of the face switch cluster 21 while the fourth switch 34 is disposed adjacent to the top right of the face switch cluster 21. Also, the fifth switch 35 is disposed adjacent to the bottom right of the face switch cluster 21.

Additionally, the first, second, third, fourth and fifth switch 31-35 are programmable by the operator 24.

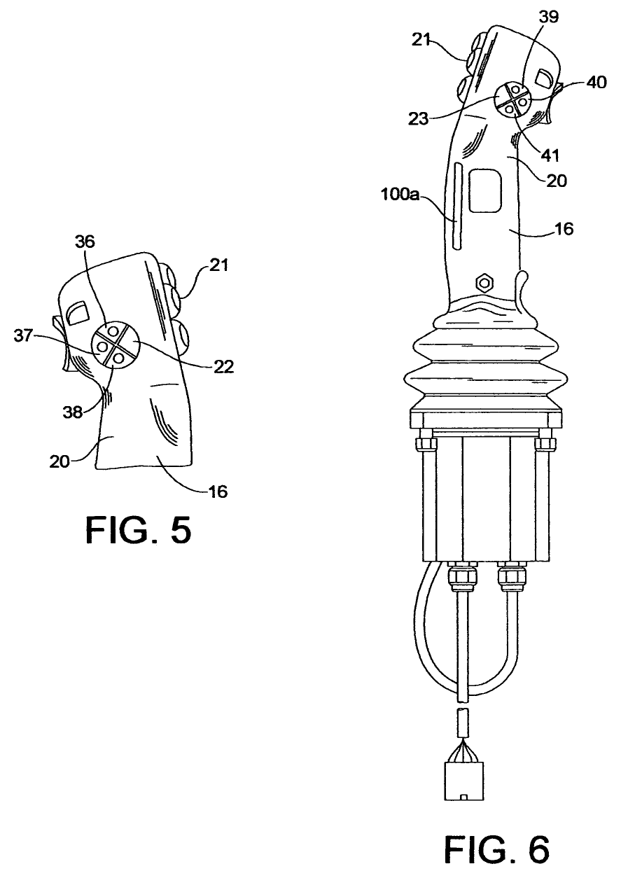

FIG. 5 is a view taken on the line 5-5 of FIG. 2. As shown in FIG. 5, the a plurality of clusters of switches 21-23 also includes a left switch cluster 22 which is disposed on the distal end 20 of the joystick 16 on the left side thereof relative to the operator 24 when operating the control device 10.

Furthermore, the left switch cluster 22 includes a first, second and third switching device 36, 37 and 38 respectively. The first switching device 36 is disposed adjacent to the top of the left switch cluster 22 and the second switching device 37 is disposed adjacent to the middle of the left switch cluster 22. Also, the third switching device 38 is disposed adjacent to the bottom of the left switch cluster 22.

Moreover, the first switching device 36 functions to increase the spreader rate and the second switching device 37 functions to turn the spreader 14 on and off. Also, the third switching device 38 functions to decrease the spreader rate.

FIG. 6 is a view taken on the line 6-6 of FIG. 2. As shown in FIG. 6, the a plurality of clusters of switches 21-23 includes a right switch cluster 23 which is disposed on the distal end 20 of the joystick 16 on the right side thereof relative to the operator 24 when operating the control device 10.

The right switch cluster 23 includes a first, second and third switch mechanism 39, 40 and 41 respectively. The first switch mechanism 39 is disposed adjacent to the top of the right switch cluster 23 while the second switch mechanism 40 is disposed adjacent to the middle of the right switch cluster 23. Also, the third switch mechanism 41 is disposed adjacent to the bottom of the right switch cluster 23.

Furthermore, the first switch mechanism 39 functions to increase the rate of rotation of a spinner 42 shown in FIG. 1. The second switch mechanism 40 functions to provide a spreader blast and the third switch mechanism 41 functions to decrease the rotation rate of the spinner 42.

The switches 3141 and particularly the switches 31-35 are contact less capacitance operator mode selection switches. Also, the switches 31-41 and particularly the switches 31-35 are backlit switches.

As shown in FIGS. 2 and 6, the present invention also includes a capacitance sensor 100a which is located in the joystick 16. The arrangement is such that when the operator 24 grips the joystick 16, the device 10 is activated. In this manner, when the operator's hand is not present, the device 10 will not activate any Pulse Width Modulated or current driven outputs, thereby providing a safety interlock system.

In operation of the device 10, the operator programs the switches 31-41 to perform all of the functions of a snow and ice control operation. Accordingly, the lifting and lowering of the plow 44 shown in FIG. 1 can be controlled by programmed switches. Also, side to side movement of the plow 44 can be controlled by further switches of the switches 31-41. Movement of the materials within the spreader can be controlled by one or more of the switches 31-41 including the control of one or more material conveyors for moving the materials to the front or to the rear of the dump body. By the programming of the various switches, the operator 24 is able to control all of the spreader functions through the single joystick control device so that the spreader functions and operations are greatly simplified.

The present invention provides a unique arrangement for centrally locating the multiple control functions of a spreader for the snow and ice control industry.

What is claimed is:

1. A joystick control device for use in a cab of a spreader for the snow and ice control industry, said control device comprising:
a multi-axis joystick disposed within the cab, said joystick having a proximal and a distal end, said proximal end of said joystick being secured to the cab; and
a plurality of clusters of switches mounted on said distal end of said joystick such that in operation of said control device, an operator within the cab operates said switches for controlling the snow and ice control functions of the spreader.

2. A joystick control device as set forth in claim 1 wherein
said joystick has an x and y axes.

3. A joystick control device as set forth in claim 2 wherein
said x axis includes movement of said distal end of said joystick between left and right;
said y axis includes movement of said distal end of said joystick between a forward and a reverse disposition.

4. A joystick control device as set forth in claim 3 wherein
said joystick has a z axis;
said z axis includes a rotational movement of said distal end of said joystick.

5. A joystick control device as set forth in claim 4 wherein
said x, y and z axes are operator programmable.

6. A joystick control device as set forth in claim 1 wherein
said a plurality of clusters of switches includes:
a face switch cluster which is disposed on said distal end of said joystick facing the operator when operating said control device.

7. A joystick control device as set forth in claim 6 wherein
said face switch cluster includes:
a first, second, third, fourth and fifth switch;
said first switch being disposed adjacent to the bottom left of said face switch cluster;
said second switch being disposed adjacent to the top left of said face switch cluster;
said third switch being disposed adjacent to the top center of said face switch cluster;
said fourth switch being disposed adjacent to the top right of said face switch cluster;
said fifth switch being disposed adjacent to the bottom right of said face switch cluster.

8. A joystick control device as set forth in claim 7 wherein
said first, second, third, fourth and fifth switch are each operator programmable.

9. A joystick control device as set forth in claim 1 wherein
said a plurality of clusters of switches includes:
a left switch cluster which is disposed on said distal end of said joystick on the left side thereof relative to the operator when operating said control device.

10. A joystick control device as set forth in claim 9 wherein
said left switch cluster includes:
a first, second and third switching device;
said first switching device being disposed adjacent to the top of said left switch cluster;
said second switching device being disposed adjacent to the middle of said left switch cluster;
said third switching device being disposed adjacent to the bottom of said left switch cluster.

11. A joystick control device as set forth in claim 10 wherein
said first switching device functions to increase the spreader rate;
said second switching device functions to turn the spreader on and off;
said third switching device functions to decrease the spreader rate.

12. A joystick control device as set forth in claim 1 wherein
said a plurality of clusters of switches includes:
a right switch cluster which is disposed on said distal end of said joystick on the right side thereof relative to the operator when operating said control device.

13. A joystick control device as set forth in claim 12 wherein
said right switch cluster includes:
a first, second and third switch mechanism;
said first switch mechanism being disposed adjacent to the top of said right switch cluster;
said second switch mechanism being disposed adjacent to the middle of said right switch cluster,
said third switch mechanism being disposed adjacent to the bottom of said right switch cluster.

14. A joystick control device as set forth in claim 13 wherein
said first switch mechanism functions to increase a spinner rotation rate;
said second switch mechanism functions to provide a spreader blast;
said third switch mechanism functions to decrease a spinner rotation rate.

15. A joystick control device as set forth in claim 1 wherein
said switches are contact less capacitance operator mode selection switches.

16. A joystick control device as set forth in claim 1 wherein
said switches are backlit switches.

17. A joystick control device as set forth in claim 1 further including:
a capacitance sensor disposed within said joystick, the arrangement being such that when the operator grips said joystick, said joystick control device is activated so that when the operator's hand is not present, said joystick control device will not activate any current driven outputs, thereby providing a safety interlock system.

18. A joystick control device for use in a cab of a spreader for the snow and ice control industry, said control device comprising:
a multi-axis joystick disposed within the cab, said joystick having a proximal and a distal end, said proximal end of said joystick being secured to the cab;
a plurality of clusters of switches mounted on said distal end of said joystick such that in operation of said control device, an operator within the cab operates said switches for controlling the snow and ice control functions of the spreader; and
said joystick having x, y and z axes.

19. A joystick control device for use in a cab of a spreader for the snow and ice control industry, said control device comprising:
a multi-axis joystick disposed within the cab, said joystick having a proximal and a distal end, said proximal end of said joystick being secured to the cab;
a plurality of clusters of switches mounted on said distal end of said joystick such that in operation of said control device, an operator within the cab operates said switches for controlling the snow and ice control functions of the spreader;
said joystick having an x and y axes;
said x axis including movement of said distal end of said joystick between left and right;
said y axis including movement of said distal end of said joystick between a forward and a reverse disposition;
said joystick having a z axis;
said z axis including a rotational movement of said distal end of said joystick;
said x, y and z axes being operator programmable;
said a plurality of clusters of switches including:
a face switch cluster which is disposed on said distal end of said joystick facing the operator when operating said control device;
said face switch cluster including:
a first, second, third, fourth and fifth switch;
said first switch being disposed adjacent to the bottom left of said face switch cluster;
said second switch being disposed adjacent to the top left of said face switch cluster;
said third switch being disposed adjacent to the top center of said face switch cluster;
said fourth switch being disposed adjacent to the top right of said face switch cluster;
said fifth switch being disposed adjacent to the bottom right of said face switch cluster.
said first, second, third, fourth and fifth switch each being operator programmable;
said a plurality of clusters of switches including:
a left switch cluster which is disposed on said distal end of said joystick on the left side thereof relative to the operator when operating said control device;
said left switch cluster including:
a first, second and third switching device;
said first switching device being disposed adjacent to the top of said left switch cluster;
said second switching device being disposed adjacent to the middle of said left switch cluster;
said third switching device being disposed adjacent to the bottom of said left switch cluster;
said first switching device functioning to increase the spreader rate;
said second switching device functioning to turn the spreader on and off;
said third switching device functioning to decrease the spreader rate;
said a plurality of clusters of switches including:
a right switch cluster which is disposed on said distal end of said joystick on the right side thereof relative to the operator when operating said control device;
said right switch cluster including:
a first, second and third switch mechanism;
said first switch mechanism being disposed adjacent to the top of said right switch cluster;
said second switch mechanism being disposed adjacent to the middle of said right switch cluster;
said third switch mechanism being disposed adjacent to the bottom of said right switch cluster;
said first switch mechanism functioning to increase a spinner rotation rate;
said second switch mechanism functioning to provide a spreader blast;
said third switch mechanism functioning to decrease a spinner rotation rate;
said switches being contact less capacitance operator mode selection switches; and
said switches being backlit switches.
